(19) United States
(12) Patent Application Publication
(10) Pub. No.: US 2006/0245056 A1
(43) Pub. Date: Nov. 2, 2006

(54) THIN-FILM STRUCTURE WITH COUNTERACTING LAYER

(76) Inventor: Jhy-Chain Lin, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/307,049

(22) Filed: Jan. 20, 2006

(30) Foreign Application Priority Data
Apr. 29, 2005 (CN) 200510034506.5

(51) Int. Cl. G02B 1/10

(52) U.S. Cl. 359/586; 359/589

(57) ABSTRACT

The present invention relates to a thin-film structure with counteracting layer. The thin-film structure includes a transparent substrate, a multilayer film stack and a counteracting layer. The substrate has a first surface and an opposite second surface. The film stack is formed on the first surface of the substrate for providing an optical function. The counteracting layer is formed on the second surface of the substrate. The stress compensation is composed of a single layer having a predetermined thickness for compensating an internal stress produced by the film stack.

### FIELD OF THE INVENTION

The present invention relates generally to optical thin-film structures, and particularly to a thin-film structure having a counteracting layer.

### DESCRIPTION OF RELATED ART

In recent years, thin-film manufacturing techniques have been widely used in a variety of fields such as micro-electronics, mechanics, optics and so on. In the field of optics, a thin film is generally formed on a substrate by a physical or chemical process. The thin film may be composed of a single layer or multi layers. Such thin-film structure is generally used as an optical filter. The operation principle of the thin-film filter mainly falls into two classes. One is based on a material of the thin-film filter can absorb light. The other is based on interference phenomenon. A thickness of the thin-film filter is generally configured to be appropriate times of the wavelength of light.

An IR(Infrared Ray) cut filter is essentially a thin film formed on one side of a substrate. The thin film generally includes a number of layers or even dozens of layers. An internal stress is unavoidably produced due to the multilayer thin film formed on the substrate. This internal stress may make the substrate tend to get warped, or even cause the thin film stack to be peeled off from the substrate.

Referring to FIG. 1, this shows an IR cut thin-film filter 100. The thin-film filter 100 has a substrate 10. A first multilayer thin film stack 11 and a second multilayer thin film stack 12 are formed on opposite sides of the substrate 10. In order to avoid the substrate 10 becoming warped, a thickness of the first multilayer thin film stack 11 is configured to be equal to that of the second multilayer thin film stack 12, so that an internal stress produced by the first multilayer thin film stack 11 is counteracted by the second multilayer thin film stack 12.

However, the internal stress is generally associated with the thickness of the thin film stack and the number of the layers thereof. In order to counteract the internal stress produced by the first multilayer thin film stack with the internal stress produced by the second multilayer thin film, the thickness and the number of the layers of the first multilayer thin film stack has to be configured to be equal to those of the second multilayer thin film stack. This limits the configuration of the first and second multilayer thin film stack.

Therefore, what is needed, is to provide an improved thin-film structure that overcomes the above-described problems.

### SUMMARY OF INVENTION

An embodiment of a thin-film structure comprises a transparent substrate, a multilayer film stack and a counteracting layer. The transparent substrate has a first surface and an opposite second surface. The multilayer film stack is formed on the first surface of the transparent substrate for providing an optical function. The counteracting layer is formed on the second surface of the transparent substrate. The counteracting layer is composed of a single layer for compensating an internal stress produced by the multilayer film stack.

Other advantages and novel features of the present thin-film structure will become more apparent from the following detailed description of preferred embodiments when taken in conjunction with the accompanying drawings.

### BRIEF DESCRIPTION OF DRAWINGS

Many aspects of the present thin-film structure can be better understood with reference to the following drawings. The components in the drawings are not necessarily to scale, the emphasis instead being placed upon clearly illustrating the principles of the present thin-film structure.

FIG. 1 is a schematic, cross-sectional view of a conventional thin-film structure; and

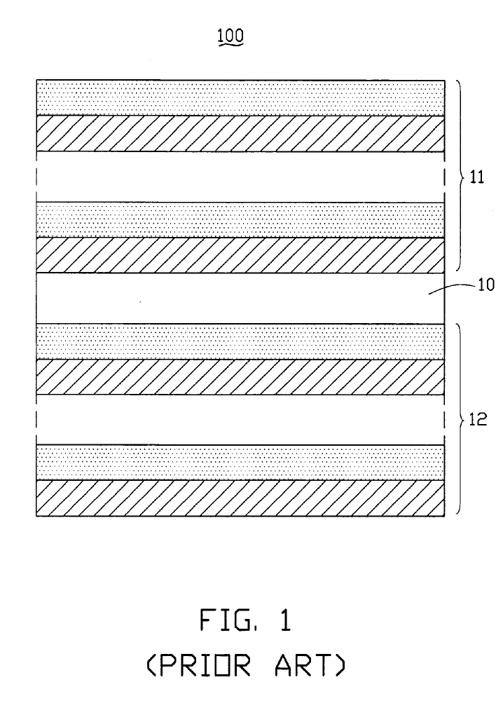

FIG. 2 is a schematic, cross-sectional view of a thin-film structure having a counteracting layer in accordance with a preferred embodiment of the present invention.

Corresponding reference characters indicate corresponding parts throughout the several views. The exemplifications set out herein illustrate at least one preferred embodiment of the present thin-film structure, in one form, and such exemplifications are not to be construed as limiting the scope of the invention in any manner.

### DETAILED DESCRIPTION

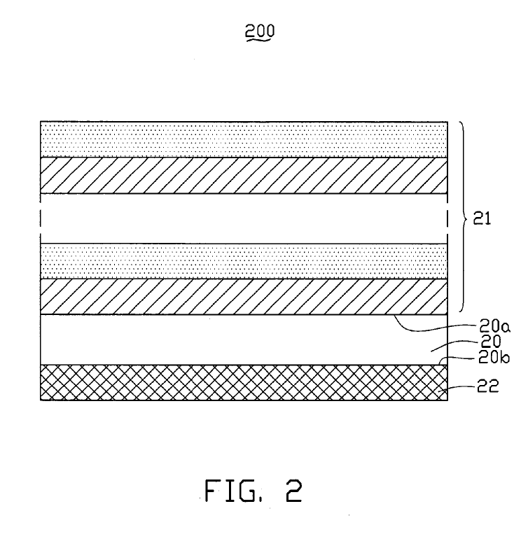

Referring to FIG. 2, a thin-film structure 200 according to a preferred embodiment of the present invention is illustrated. The thin-film structure 200 may be, for example, an infrared ray (IR) cut filter. The thin-film structure 200 includes a transparent substrate 20, a thin film stack 21 and a counteracting layer 22. The substrate 20 has a first surface 20a and an opposite second surface 20b. The film stack 21 is a multilayer thin film formed on the first surface 20a. The counteracting layer 22 is a single layer thin film formed on the second surface 20b.

The substrate 20 is generally comprised of a transparent material, such as glass, transparent plastic and the like. The film stack 21 includes a number of first layers made of a high refractive index material, and a number of second layers made of a low refractive index material. The first layers and the second layers are alternately stacked one on another. The high refractive index material includes titanium oxide (TiO₂), titanium trioxide (TiO₃), tantalum pentoxide (Ta₂O₅) and so on. The low refractive index material includes silicon oxide (SiO₂), aluminum oxide (Al₂O₃) and so on. A thickness of each alternating layers is configured according to different requirements.

The counteracting layer 22 is a single layer thin film. The counteracting layer 22 is generally comprised of a material having a high transmittance light. The transmittance of light of the counteracting layer 22 is preferably not less than 95 percents for incident light of various wavelength. In the preferred embodiment, the counteracting layer 22 is comprised of silicon dioxide. A thickness of the counteracting layer 22 is integral multiples of a half wavelength.

The film stack 21 formed on the first surface 20a is used to perform the light filtering function. In the illustrated embodiment, the film stack 21 is used to filter the infrared rays. The counteracting layer 22 formed on the second surface 20b is essentially used to compensate the internal stress produced by the film stack 21 and has no bearings on the filtering function of the IR cut filter 200. The internal stress produced by film stack 21 inherently makes the substrate 20 tend to get warped towards the second surface 20b. Similarly, the internal stress produced by the counteracting layer 22 inherently makes the substrate 20 tend to get warped towards the first surface 20a. As a result, the counteracting layer 22 can effectively prevent the substrate 20 from being warped. In a preferred embodiment, the thickness of the counteracting layer 22 is configured according to the internal stress produced by the film stack 21, and preferably to be integral multiples of a half wavelength, such that the internal stress of the film stack 21 is effectively counteracted. Thereby, the stress compensate layer 22 can prevent the substrate 20 from being warped.

Compared with the conventional thin-film structure, the film stack 21 can independently perform the optical function. The counteracting layer 22 is only provided for compensating the internal stress. The parameters such as material can be readily selected, and the layers of the film stack 21 can be configured so as to obtain the best optical performance without considering the internal stress effect. For example, the film stack 21 only needs to be formed on one side of the substrate 20, the counteracting layer 22 being formed on another side of the substrate 20. The internal stress produced by the film stack 21 can be counteracted by the counteracting layer 22. Thus the distortion or warping of the substrate 20 also can be prevented.

A method for manufacturing the thin-film structure 200 includes the following steps. Firstly, a transparent substrate 20 is provided. The substrate 20 has a first surface 20a and an opposite second surface 20b.

Secondly, a film stack 21 is formed on the first surface 20a employing the sputtering method. The film stack 21 may be used as an IR filter and includes a number of first layers made of a high refractive index material, and a number of second layers made of a low refractive index material. The first layers and the second layers are alternately stacked one on another. The material of the high refractive index material may be TiO₂, and the material of the low refractive index material may be Al₂O₃.

Thirdly, an internal stress produced by the film stack 21 is measured. The internal stress of the film stack 21 may be measured or otherwise estimated according to the thickness and material of the film stack 21.

Fourthly, a counteracting layer 22 of silicon oxide, is formed on the second surface 20b of the substrate 20. The thickness of the counteracting layer 22 may be determined according to the internal stress produced by the film stack 21. The thickness of the counteracting layer 22 is beneficially configured to be integral multiples of a half wavelength of central wavelength of the light, such that the internal stress produced by the film stack 21 can be effectively counteracted by the counteracting layer 22. Thus the thin-film structure 200 comprised of the substrate 20, the film stack 21 and the counteracting layer 22 is formed

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A thin-film structure comprising:
a transparent substrate having a first surface and an opposite second surface;
a multilayer film stack formed on the first surface of the substrate for providing an optical function; and
a counteracting layer formed on the second surface of the substrate, the counteracting layer being a single layer for compensating an internal stress produced by the film stack.

2. The thin-film structure as described in claim 1, wherein the film stack independently perform the optical function.

3. The thin-film structure as described in claim 1, wherein the film stack is configured for filtering light of a predetermined wavelength.

4. The thin-film structure as described in claim 1, wherein the film stack is comprised of a number of first layers made of a high refractive index material and a number of second layers made of a low refractive index material, the first layers and the second layers being alternately stacked one on another.

5. The thin-film structure as described in claim 4, wherein the high refractive index material is selected from the group consisting of TiO₂, TiO₃ and Ta₂O₅.

6. The thin-film structure as described in claim 4, wherein the low refractive index material is one of SiO₂ and Al₂O₃.

7. The thin-film structure as described in claim 3, wherein the counteracting layer is comprised of a material having a transmittance of more than 95% of the light.

8. The thin-film structure as described in claim 7, wherein the material of the counteracting layer is silicon oxide.

9. The thin-film structure as described in claim 3, wherein the thickness of the counteracting layer is integral multiples of a half wavelength of the light.
